(19) United States
(12) Patent Application Publication
(10) Pub. No.: US 2015/0171387 A1
(43) Pub. Date: Jun. 18, 2015

(54) BATTERY PACK AND ASSOCIATED METHODS

(71) Applicant: General Electric Company, Schenectady, NY (US)

(72) Inventors: John Raymond Krahn, Schenectady, NY (US); Kristopher John Frutschy, Clifton Park, NY (US); William Hubert Schank, JR., Howell, MI (US)

(73) Assignee: General Electric Company, Schenectady, NY (US)

(21) Appl. No.: 14/103,948

(22) Filed: Dec. 12, 2013

(51) Int. Cl. H01M 2/10; H01M 2/02

(52) U.S. Cl. CPC H01M 2/1077; H01M 2/0277

(57) ABSTRACT

A battery pack is described. The battery pack includes a plurality of electrochemical cells, wherein the electrochemical cells are isolated from each other by a concrete. The concrete includes a composite cement having from about 20 percent to about 80 percent aggregate of high packing density, by weight of the composite cement. Methods for providing electrical isolation between individual electrochemical cells are also described.

### BACKGROUND

The invention relates generally to packaging of a battery. More particularly, the invention relates to the electrical isolation of individual electrochemical cells, for example sodium cells, in a battery pack for mobile applications such as mining vehicles. The invention also relates to a method for making such a battery pack.

Batteries are essential components used to store a portion of the energy in mobile systems such as electric vehicles, hybrid electric vehicles, and non-vehicles (for example locomotives, off-highway mining vehicles, marine applications, buses and automobiles); and for stationary applications such as uninterruptible power supply (UPS) systems and “Telecom” (telecommunication systems). In the case of vehicles, the energy is often regenerated during braking, for later use during motoring. In general, energy can be generated for later use when the demand is low, thus reducing fuel consumption.

Many different types of batteries are known to exist. Among current high-temperature batteries, sodium based batteries, for example, the sodium-sulfur battery and the sodium metal halide battery, are of considerable interest because of their high power output. Normally, these batteries are made up of many cells. Each cell is electrically isolated from the adjacent cells while, at the same time, the cells are electrically connected to each other in series or in parallel arrangement. Typically, the individual cells are separated by a mica sheet or micacious wraps or foils placed between the cells for electrical insulation.

Generally, high-temperature battery operating environments are harsh for several reasons, including, but not being limited to, large changes in environmental operating temperature, extended mechanical vibrations, and the existence of corrosive contaminants. In addition, charge and discharge are accomplished under severe conditions, including large amounts of discharging current at the time of acceleration of a heavy vehicle, and the large amounts of charging current at the time of braking. Nevertheless, given the high initial capital cost, vehicle batteries are usually expected to have an extended lifetime.

However, most of the high temperature batteries are prone to failure due to mechanical vibration damage. The electrical insulation usually suffers from poor abrasion resistance, and allows relative motion between the mica sheet and the cell, and/or between adjacent cells due, in part, to mechanical vibrations. The relative motion leads to a loss in electrical connections between the cells (due to fatigue or creep of the cell-to-cell electrical connections), resulting in battery failure. The vibrations can also lead to strike failures in tight spaces, and can lead to damage to the mechanical and insulating properties of the mica sheets.

It would therefore be desirable to develop a robust battery pack of high reliability, extended lifetime, and improved electrical insulation, to be used in high vibration environments, such as mining vehicles and locomotives.

### BRIEF DESCRIPTION

According to some embodiments of the present invention, a battery pack, including a plurality of electrochemical cells, is provided. The electrochemical cells are isolated from each other by a concrete. The concrete includes a composite cement having from about 20 percent to about 80 percent aggregate of high packing density, by weight of the composite cement.

Some embodiments of the present invention further provide a method for providing electrical isolation between individual electrochemical cells in a battery pack. The method includes the steps of arranging a plurality of electrochemical cells in an array, such that each individual cell is separated from an adjacent cell by a gap, and providing a concrete comprising a composite cement in the gap between the individual cells. The composite cement includes from about 20 percent to about 80 percent aggregate of high packing density, by weight of the composite. The concrete is then cured to form a robust battery pack.

### DRAWINGS

These and other features, aspects, and advantages of the present invention will become better understood when the following detailed description is read with reference to the accompanying drawings in which like characters represent like parts throughout the drawings.

FIG. 1 is a schematic of a top view of a battery pack, in accordance with one embodiment of the present invention;

FIG. 2 is a schematic of a cross-sectional side view of the battery pack of FIG. 1, in accordance with one embodiment of the present invention;

FIG. 3 is a schematic of an electrochemical cell, in accordance with one embodiment of the present invention.

### DETAILED DESCRIPTION

As discussed in detail below, some of the embodiments of the present invention provide a high temperature concrete for the electrical isolation of individual electrochemical cells in a battery pack. These embodiments advantageously provide a robust battery pack, and avoid the risk of damaging electrical insulation between the cells during operation. The embodiments of the present invention also describe a method for providing electrical isolation between individual cells in a battery pack. The present discussion provides examples in the context of sodium batteries (e.g., sodium metal halide battery) for use with mobile systems, such as mining vehicles. However, the present invention is equivalently applicable to various other applications e.g., stationary applications, and other type of batteries.

Approximating language, as used herein throughout the specification and claims, may be applied to modify any quantitative representation that could permissibly vary, without resulting in a change in the basic function to which it is related. Accordingly, a value modified by a term or terms, such as “about”, is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. The terms “comprising,” “including,” and “having” are intended to be inclusive, and mean that there may be additional elements other than the listed elements. As used herein, the term “and/or” includes any and all combinations of one or more of the associated listed items.

The term “electrical isolation” as used herein means that each electrochemical cell in a battery pack is electrically separated from adjacent cells, with respect to cells arranged side by side. In other words, the electrical resistance between the cells is very high, minimizing the flow of electrical current (desirably less than about 10 μA) between cells through the electrical insulation.

As used herein, the term “high temperature” generally refers to temperatures above about 250 degrees Celsius (° C.), unless otherwise indicated.

According to one embodiment of the invention, a battery pack is provided. The battery pack includes a plurality of electrochemical cells, being electrically isolated from one another by a concrete including a composite cement. The composite cement includes an aggregate in an amount from about 20 percent to about 80 percent, by weight of the composite cement.

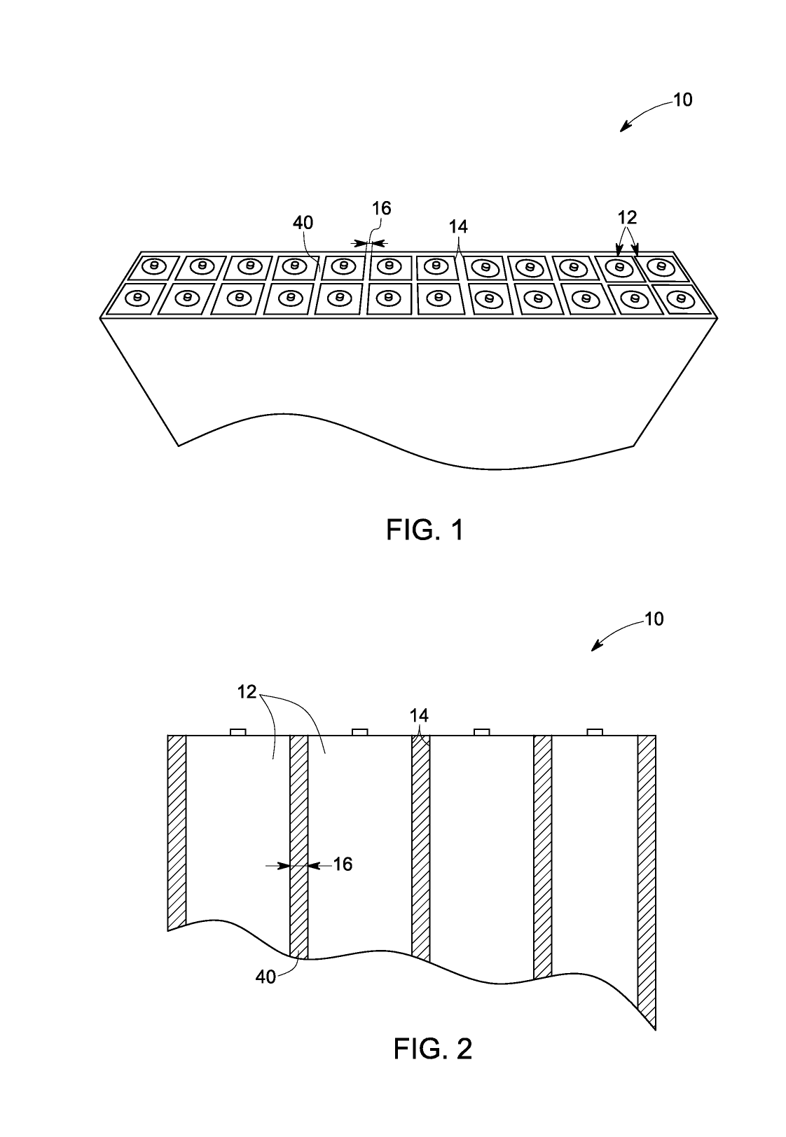

FIGS. 1 and 2 respectively illustrate schematics of a top view and a cross-sectional side view of a battery pack 10, in accordance with some embodiments of the invention. The battery pack 10 includes a plurality of electrochemical cells 12 arranged in arrays. The cells 12 may include a sodium-sulfur cell or a sodium-metal halide cell, for example. The cells 12 are stacked adjacent to each other in the pack 10, and are, electrically connected to each other in series and/or in parallel arrangement. In the illustrated embodiments, two arrays of cells 12 are shown for simplicity; however the number of cells, the number of arrays, and their electrical arrangement, typically, depend on the output requirement of the battery pack, and end use applications. Each cell 12 has an outer surface 14, which is electrically isolated from the outer surfaces of the adjacent cells by a concrete 40, disposed within a gap 16 defined between the adjacent cells. The concrete 40 includes a composite cement having an aggregate dispersed in the cement. The aggregate is present in an amount from about 20 percent to about 80 percent, by weight of the composite cement.

The gap 16 between the adjacent cells can be as small as possible, i.e., the minimum dimension required to electrically isolate the individual cells 12. In some embodiments, the gap 16 between the individual cells may be from about 1 millimeter to about 5 millimeters, and in some specific embodiments, from about 1 millimeter to about 2 millimeters.

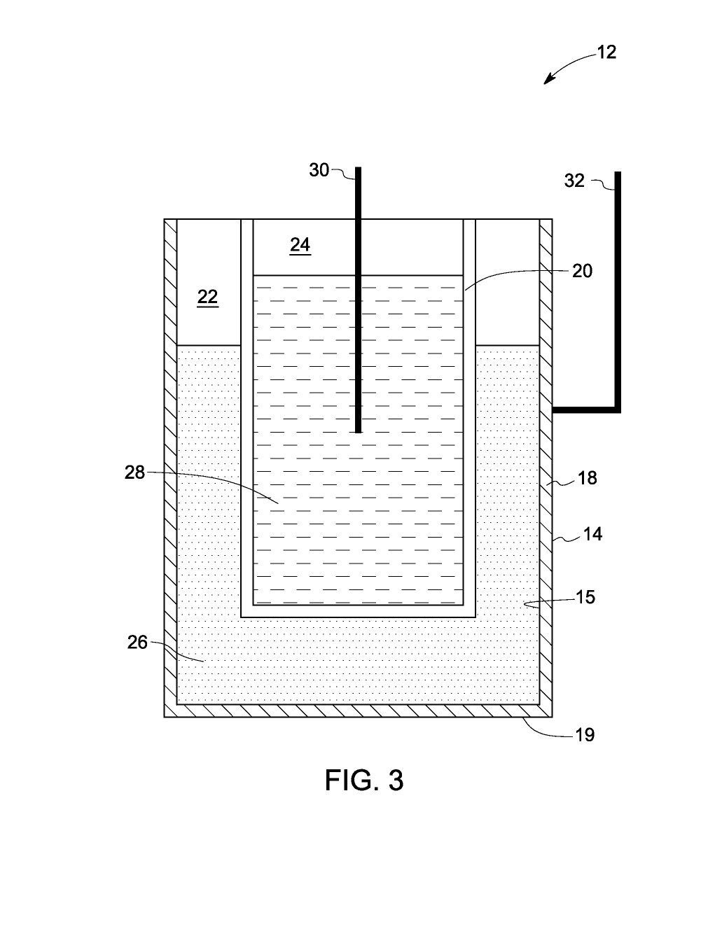

FIG. 3 depicts a schematic of an exemplary embodiment of one of the cells 12 of FIGS. 1 and 2. The electrochemical cell 12 has an ion-conductive separator tube 20 disposed in a cell casing 18. The casing 18 is, generally, a container having a base 19 and a length or height perpendicular to the base 19. The casing 18 has an outer surface 14 and an inner surface 15. An anode chamber 22 is defined between an inner surface 15 of the casing 18 and the separator 20. Suitable materials for the casing 18 may be selected from the group consisting of nickel, mild steel, stainless steel, nickel-coated steel, molybdenum and molybdenum-coated steel, as examples.

The tube 20 further defines a cathode chamber 24, inside the tube 20. The anode chamber 22 is usually filled with an anode material 26, e.g. sodium, and the cathode chamber 24 contains a cathode material 28. In some instances, the cathode material 28 includes an alkali metal halide (e.g., nickel and sodium chloride), and a molten electrolyte, usually sodium chloroaluminate (NaAlCl₄). In some other instances, the cathode material 28 includes sulfur. The separator tube 20 provides ionic communication between the anode chamber 22 and the cathode chamber 24, and is usually made of β-alumina or β″-alumina. The separator tube 20 may have a cross-sectional profile normal to the axis that is a circle, a triangle, a square, a cross, a star, or a cloverleaf shape. An exemplary electrochemical cell is described in Patent Application Publication No. US2012/0219843, which is incorporated herein by reference.

The cell 12 further includes current collectors, 30 and 32 in electrical communication with the respective chambers. The casing 18 may also act as a current collector, in some instances. The anode and the cathode chambers 22 and 24 can be sealed to the separator 20 by a sealing structure (not shown in drawings), for example a gasket, a sealing strip or a sealing composition that is effective at a temperature greater than about 300 degrees Celsius. The sealing structure provides separation between the contents of the cell and the environment, and also prevents leakage and contamination.

The electrochemical cells 12 may operate in a temperature range of from about 250 to about 400 degrees Celsius. In one embodiment, the operating temperature of the cell may be in a range of from about 270 degrees Celsius to about 350 degrees Celsius, and in certain embodiments, may reach up to about 400 degrees Celsius.

The shape and size of the several components discussed above with reference to FIGS. 1-3 are only illustrative for the understanding of the battery pack and the cell structure; and are not meant to limit the scope of the invention.

According to some embodiments of the invention, a method for making a battery pack is provided. The method involves the steps of arranging a plurality of electrochemical cells 12 in an array, such that an individual cell 12 is separated from an adjacent cell by a gap 16, and providing a concrete in the gap 16 to electrically isolate the cells from one another. In one embodiment, the concrete includes a composite cement having from about 20 percent to about 80 percent aggregate, by weight of the composite cement. The method further includes a curing step to harden the concrete to form a resulting robust pack of cells.

To satisfy the high temperature and safety requirements, a cement based composite is selected for the electrical isolation of the cells that provides a robust battery pack, and is sustainable at high temperatures, i.e., at least at the operating temperature of the electrochemical cell. In addition, it is desirable to choose a thermally conductive cement to dissipate heat generated during the operation of the battery. Suitable cement materials may include, but are not limited to, calcium aluminate compounds, phosphate-containing compounds, or a combination thereof. In some embodiments, substantially all of the cement is comprised of either the calcium aluminate compound or the phosphate-containing compound.

Cement is usually mixed with water for its application. However, diluting the cement with water results in cracking caused by cure-shrinkage, because the cement undergoes dehydration between about 100 degrees Celsius to about 300 degrees Celsius. Thus very low water content cement formulas are desirable. Aspects of the present invention provide an aggregate added to the cement to form a concrete. Furthermore, the aggregate may be added with such a geometry i.e. particle shape and particle size distribution that provide high packing density, to allow for high aggregate loadings while maintaining a low viscosity. A high aggregate loading may help in minimizing or eliminating cracking usually caused by cure-shrinkage. The resulting concrete is flowable within the gaps 16 between the cells 12, due to reduced viscosity.

The aggregate includes an electrically insulating material such as oxides, nitrides, and silicates. Non-limiting examples of electrically insulating particulate material may include aluminum oxide (i.e. alumina), magnesium oxide, zirconium oxide, boron nitride, or a combination thereof. An oxide aggregate may be suitable because of several properties, including high stability in the corrosive environment, high chemical stability, and hardness. In certain embodiments, the aggregate includes alumina. In addition, other materials or aggregates can be used that beneficially enhance thermal properties.

In one embodiment, the aggregate has a high packing density in the composite cement. Packing density can be defined as an amount of material (e.g., the aggregate) per unit volume. Higher packing density of the aggregate in the composite cement results in lower water absorption by the composite cement, which eventually minimizes the cure shrinkage (and the concomitant cracking) of the concrete. The packing density of the aggregate in the concrete is attributed to the amount, geometry (i.e. shape of particles) and particle size distribution of the aggregate. The amount of the aggregate in the composite cement may be at least about 20 percent, by weight of the composite cement. In one embodiment, the aggregate may be present in an amount as high as 100 percent. However, in some embodiments, the amount of aggregate may range from about 20 percent to about 80 percent, and in some specific embodiments, from about 50 percent to about 70 percent, by weight of the composite cement.

The aggregate may include particles in a variety of shapes or forms, e.g., spheres, particulates, fibers, platelets, whiskers, rods, or a combination of two or more of the foregoing. Furthermore, the aggregate may be used in a form with a specified particle size, particle size distribution, average particle surface area, particle shape, and particle cross-sectional geometry. (Other specifications may also be adhered to, depending on the type of constituent, e.g., an aspect ratio in the case of whiskers or rods).

The particle size distribution of the aggregate may be important, and helps in attaining high packing density of the aggregate, and thus affects the viscosity of the resulting concrete thereof. In some embodiments, the aggregate should include substantially spherical particles of an average particle size less than about 1 millimeter. In some instances, the average particle size may range from about 0.1 millimeter to about 1 millimeter. In some embodiments that are preferred for certain end uses, at least about 75 percent particles are substantially spherical. It may sometimes be desirable to have substantially all of the particles substantially spherical.

In some other embodiments, the particle size distribution may be bimodal. The aggregate may include a fine phase and a coarse phase. The coarse phase may include particles of an average particle size ranging from about 0.5 millimeter to about 1 millimeter. The fine phase may include particles of an average particle size from about 50 microns to about 500 microns, and more specifically, from about 80 microns to about 250 microns. The fine particles may sit in the void spaces of the coarse phase, and thus the combination of the coarse and the fine phase forms a highly packed aggregate.

The cement and the aggregate can be mixed together manually, or mechanically, e.g. by milling techniques. The resulting composite cement is generally mixed with an amount of water to make a concrete. In one embodiment, the concrete is flowable. As used herein, flowable or “flowability” of the concrete refers to a flow of concrete under pressure. That is, concrete may not flow by itself, but flows when an external force/action is applied. For example, the concrete flows within the gaps between the cells when the cells are pushed into the concrete. In some embodiments, the concrete, in a required amount, can be poured into a container (e.g., a steel box). Individual cells can then be pushed down into the concrete, allowing the concrete to flow (rise up) within the gap 16 between the cells 12. The cells 12 can be arranged and pushed into the concrete with the help of a jig which aligns them in arrays, leaving a gap between cells.

In some other embodiments, the cells 12 (FIGS. 1 and 2) may be first arranged in desired arrays in the container, maintaining a gap 16 between the individual cells. After arranging the cells 12, the concrete may be provided in the gaps 16 between the cells 12. The flowable concrete can be poured or filled in the container, and allowed to flow within the gaps 16. In some instances, the concrete may be allowed to flow within the gaps 16 until the concrete is filled up to about half the height of the cells.

The concrete is then allowed to cure. In one instance, the concrete can be cured at room temperature. In one instance, curing may include a heat treatment step at a temperature between about 50 degrees Celsius and about 150 degrees Celsius. The curing process may also be performed in multiple sub-steps, and each sub-step can be carried out at a different temperature. The method further includes the step of making electrical connections between the cells. Individual cells 12 can be electrically connected in series and/or in parallel arrangements.

After curing, the concrete may become hard, and form hard surroundings (boundary regions) around each cell 12. The resulting battery pack is a brick-like structure, that is resistant to harsh mechanical conditions, and does not get damaged due to vibrations or shocks in a mobile system such as vehicles, locomotives etc. The concrete 40 may further provide corrosion and abrasion protection to the cell. Moreover, use of the cement based material for the packaging of the electrochemical cells adds weight to the battery pack (makes the battery heavy), which is an additional benefit for some of specific systems such as mining vehicles. Thus, the present battery pack provides vibration absorption, corrosion resistance, electrical insulation, and thermal management between the cells.

Some embodiments provide a protective coating for the concrete 40 in the battery pack 10 (FIGS. 1 and 2). The protective coating can be applied to the exposed portions of the cured concrete 40. The coating may reduce or prevent cold leakage issues during high humidity conditions. Cold leakage is a current that flows in an electrochemical cell even when the cell is below its operating temperature, for example less than about 200 degrees Celsius. In one embodiment, a protective coating includes a sealer. Suitable sealers may include silicone oil, silicone T-resins, or a combination thereof. In one embodiment, the sealer may include a silicone oil with high phenyl content. The sealer can be impregnated into, or applied by any known suitable coating techniques on the exposed surfaces of the cured concrete 40.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A battery-pack, comprising:
a plurality of electrochemical cells, electrically isolated from each other by a concrete comprising a composite cement having from about 20 percent to about 80 percent aggregate of high packing density, by weight of the composite cement.

2. The battery-pack of claim 1, wherein the plurality of electrochemical cells are electrically connected in series, in parallel, or in a combination of series and parallel arrangements.

3. The battery-pack of claim 1, wherein the plurality of electrochemical cells are arranged such that a gap between adjacent cells is in a range from about 1 millimeter to about 5 millimeters.

4. The battery-pack of claim 1, wherein the composite cement comprises a calcium aluminate compound, a phosphate-containing compound, or a combination thereof.

5. The battery-pack of claim 1, wherein the composite cement comprises from about 50 percent to about 70 percent aggregate, by weight of the composite cement.

6. The battery-pack of claim 1, wherein the aggregate comprises an electrically insulating material selected from the group consisting of oxides, nitrides, and silicates.

7. The battery-pack of claim 6, wherein the electrically insulating material comprises alumina, magnesium oxide, zirconia, boron nitride, or a combination thereof.

8. The battery-pack of claim 1, wherein the aggregate comprises substantially spherical particles.

9. The battery-pack of claim 1, wherein the aggregate comprises particles of an average particle size ranging from about 50 microns to about 1 millimeters.

10. The battery-pack of claim 1, wherein the aggregate has a bimodal particle size distribution.

11. The battery-pack of claim 10, wherein the aggregate comprises a coarse phase and a fine phase.

12. The battery-pack of claim 11, wherein the coarse phase comprises particles of an average particle size ranging from about 0.5 millimeter to about 1 millimeter.

13. The battery-pack of claim 11, wherein the fine phase comprises particles of an average particle size from about 50 microns to about 200 microns.

14. The battery-pack of claim 1, wherein the concrete is flowable before curing.

15. The battery-pack of claim 1, wherein a sealer is disposed on an exposed surface of the concrete.

16. The battery-pack of claim 15, wherein the sealer comprises silicone oil, silicone T-resins, or a combination thereof.

17. The battery-pack of claim 1, wherein the electrochemical cell is a sodium metal halide cell or a sodium sulfur cell.

18. A method for providing electrical isolation between individual electrochemical cells in a battery-pack, comprising the step of:
arranging a plurality of electrochemical cells in an array, such that any individual cell is separated from an adjacent cell by a gap;
providing a flowable concrete in the gap between the individual cells, wherein the concrete comprises a composite cement comprising from about 20 percent to about 80 percent aggregate of high packing density, by weight of composite; and
curing the concrete.

19. The method of claim 18, wherein the gap between the individual cells is in a range from about 1 millimeter to about 5 millimeters.

20. The method of claim 18, wherein the concrete is flowable before the curing step.

21. The method of claim 18, wherein providing the concrete in the gap comprises allowing the concrete to flow in the gap between the individual cells untill the concrete is filled up to about half of a height of the cell.

22. The method of claim 18, wherein the curing step comprises heating the concrete at a temperature from room temperature to about 300 degrees Celsius.

23. The method of claim 18, wherein the composite cement comprises from about 50 percent to about 70 percent of aggregate, by weight of the composite cement.

24. The method of claim 18, further comprising a step of electrically connecting the electrochemical cells in series, in parallel, or in a combination of series and parrallel thereof.

25. The method of claim 18, further comprising applying a sealer on exposed surfaces of the concrete after performing the curing step.
